(19) United States
(12) Patent Application Publication
(10) Pub. No.: US 2010/0005274 A1
(43) Pub. Date: Jan. 7, 2010

(54) VIRTUAL FUNCTIONAL UNITS FOR VLIW PROCESSORS

(75) Inventor: Jan-Willem Van De Waerdt, San Jose, CA (US)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP, B.V., Eindhoven (NL)

(21) Appl. No.: 12/518,500

(22) PCT Filed: Dec. 11, 2007
(86) PCT No.: PCT/IB2007/055016

§ 371 Date: Jun. 10, 2009

Related U.S. Application Data
(60) Provisional application No. 60/874,529, filed on Dec. 11, 2006.

(51) Int. Cl. G06F 9/38

(52) U.S. Cl. 712/203; 712/E09.045

(57) ABSTRACT

A virtual functional unit design is presented that is employed in a statically scheduled VLIW processor “Virtual” views of the function unit appear to the processor scheduler that exceed the number of physical instantiations of the functional unit. As a result, significant processor performance improvements can be achieved for those types of functional units that are too difficult or too costly to physically duplicate. By providing different virtual views to the different clusters of a VLIW processor, the compiler/scheduler can generate more efficient code for the processor, than a processor without virtual views and the physical unit restricted to a subset of the processor's clusters. The compiler/scheduler guarantees that the restrictions with respect to scheduling of operations for functional units with multiple virtual views is met. NON-clustered processors also benefit from virtual views. By providing multiple virtual views in multiple issue slots of a physical function unit, the compiler/scheduler has more freedom to schedule operations for the functional unit.

This invention relates to microcomputer systems, and more particularly to VLIW processors with many issue slots with bypass networks, and where a single physical functional processor unit is virtualized for two or more issue slots with bypass networks.

Processor designs have made considerable strides in the last fifty years. Increasing semiconductor circuit densities in general has allowed for higher performance levels using fewer components, and at reduced costs. When implemented with CMOS process technology, low power implementations are made possible.

The embedded consumer markets for audio and video processing are cost-driven. Such devices were initially implemented with dedicated hardware that could deliver the required performance at price points lower than was possible with programmable processors. Later, the increased complexity of the newer audio and video standards made programmability economically more viable, and the higher levels of performance offered by application specific processors made programmability very practical.

In the past, MPEG2 video processing could be economically implemented with dedicated hardware. But the newer, higher performing H.264/AVC video processing is now best done by application (domain) specific processors. As a result, recent consumer devices now include programmable processing performance levels that exceed those of the IBM mainframes of the 1960's. Low power processor implementations make battery-operated mobile phones, and other portable devices practical.

The TM3270 is the latest media-processor in the NXP (ex-Philips) Semiconductors TriMedia architecture family. It is an application domain specific processor for both video and audio processing, and provides a programmable media-processing platform for the embedded consumer market. For details, see, J. W. van de Waerdt, The TM3270 Media-processor, pp. 183, October 2006, ISBN 90-9021060-1, PhD Thesis (BibTeX). Download on the Internet from, http://ce.et.tudelft.nl/publicationfiles/1228_{—}587_thesis_JAN_WILLEM.pdf

Typically, very long instruction word (VLIW) processors are statically scheduled processors, like the NXP TM3270 and Texas Instruments TMS320C6x. The assignment of operations to VLIW processor issue slots and functional units is done by a compiler/scheduler at “compile” time, rather than at “execution” time. Assignments at “execution” time are done by run-time scheduled processors, e.g., super-scalar processors. So, the compiler/scheduler must have detailed knowledge of the VLIW processor's issue slots and functional units.

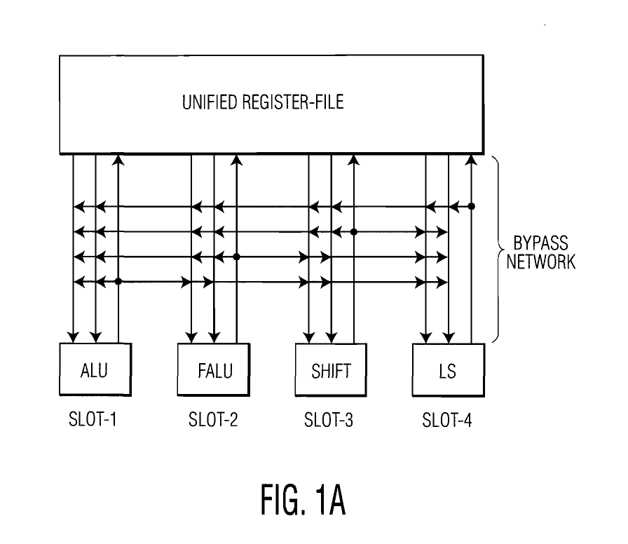

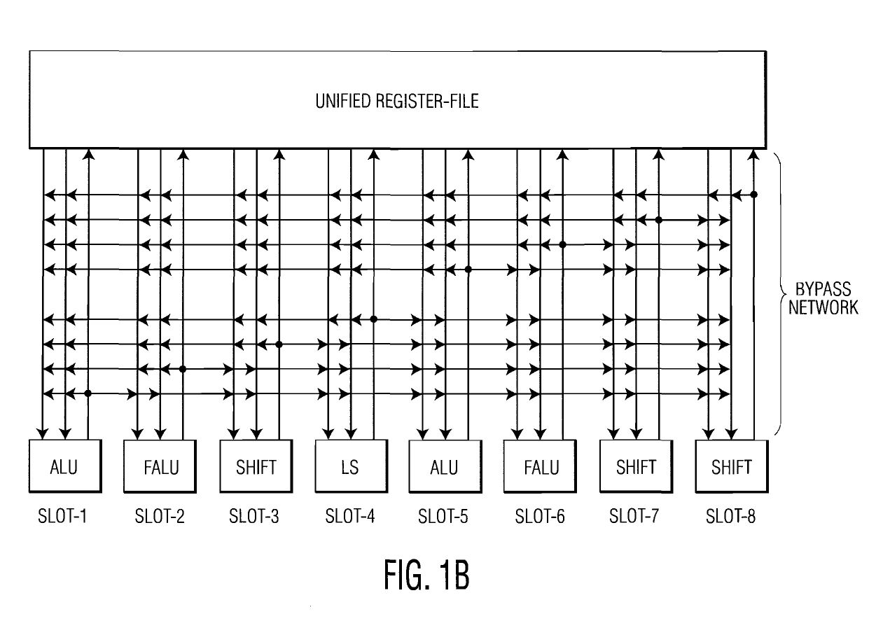

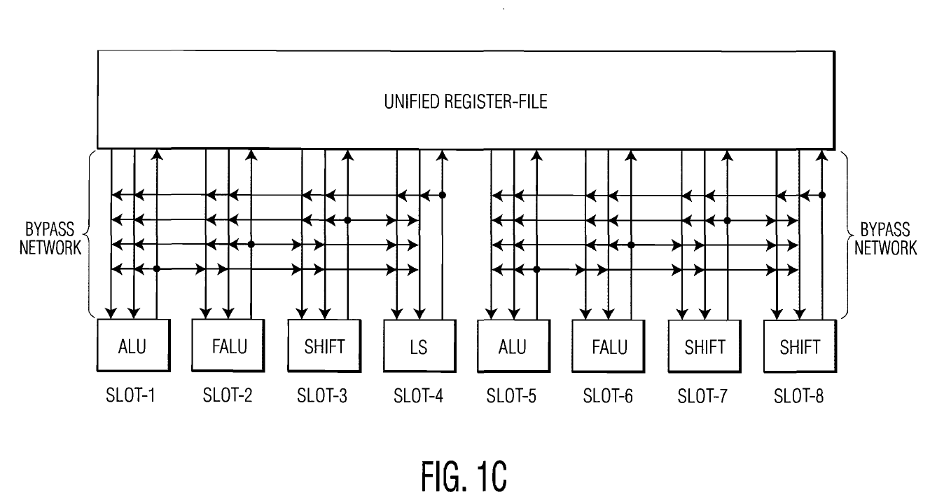

In a typical 4-issue slot-VLIW processor, as represented in FIG. 1A, four different types of functional units are available to the VLIW compiler/scheduler. E.g., issue slot-1: an arithmetic logic unit (ALU); issue slot-2: a floating-point arithmetic unit (FALU); issue slot-3: a SHIFTER, for barrel-shifter operations; and, issue slot-4: an LS, for load and store operations.

Source operands will come from a unified register-file, and operation results are put into the same register-file. If each functional unit takes a single cycle to perform an operation, then the functioning of the compiler/scheduler can be explained here more simply. See Table-I. Each NOP indicates no-operation, and is a waste of resources because the associated issue slot-does not perform an operation. So the fewer the NOP's inserted, the better.

TABLE I

| | Issue | Issue | Issue | Issue |
|---|---|---|---|---|
| | slot-1 | slot-2 | slot-3 | slot-4 |
| VLIW | ADD r2 | NOP | NOP | LD32 |
| i: | r3 −> r4 | | | [r5] −> r6 |
| VLIW | NOP | NOP | SLL r7 | NOP |
| i + 1: | | | r6 −> r8 | |

The code in Table-I represents two sequential VLIW instructions executed by the processor. Each VLIW instruction can invoke four operations assigned to specific issue slots. Some are NOP operations. For example, the LD32 operation in issue slot-4 of the first instruction (i) produces a result that will be needed by the SLL operation in issue slot-3 in the next successive VLIW instruction (i+1).

In this ideal example, the result of each operation is available to all the other operations in a successive VLIW instruction because all the functional units needed only a single cycle to perform their operations. The operand data is communicated between functional units through the register-files. But such register communication would create critical timing paths in the processor. In usual practice, if an operation result is needed by an operation in a successive VLIW instruction (instruction i+1), it has to be communicated through a bypass network, e.g., as in FIG. 1A. If the operation result is used in a later VLIW instruction (i+2, i+3, i+4, etc.), it can be communicated through a register-file. The use of bypass networks alleviates critical timing paths that would be present if all communication had to be passed through register-files.

Higher performance VLIW processors can be constructed by increasing the number of issue slots. For example, an 8-issue slot-processor with correspondingly more functional units may offer double the performance over a 4-issue slot-processor. See FIG. 1B. The additional four issue slots (slots 5-8) might have the following functional units: issue slot-5: an ALU; issue slot-6: an FALU; issue slot-7: a SHIFTER; and issue slot-8: another SHIFTER.

Bypass networks for 8-issue slot-processors are far more complex and expensive than those in 4-issue slot-machines. Such high-complexity bypass networks can easily become the critical timing path in an 8-issue slot-processor design. So the Texas Instruments VLIW processors use clustering, in which eight issue slots are grouped into two clusters of four, e.g., issue slots 1-4 and 5-8. See, FIG. 1C. Each of the clusters has its own bypass network, but only with the complexity of a 4-issue slot-machine. Such bypass network complexity reduction keeps it from becoming the critical timing path in the processor workings.

Such clustering comes at a performance and functionality cost. An operation result cannot be communicated to another operation in the other cluster by the next successive VLIW instruction (i+1). The required bypass path is not provided for in the two-cluster bypass network. Inter-cluster communication must pass through a unified register-file, and that adds an additional cycle time to when the operand data will be made available.

For example, if an FADD operation in an instruction needs the results from an ADD operation in a issue slot-5 instruction (i), then the VLIW compiler/scheduler should use its knowledge of issue slot clustering to assign the next instruction (i+1) to do the FADD operation in the same cluster, e.g., by a FADD operation in issue slot-6. If it were assigned to another cluster, such as an FADD operation in issue slot-2, it would have to be delayed until instruction (i+2). This to account for the latency caused by the data having to flow through the unified register file. As a result, the ADD-FADD operation sequence can be executed in two, rather than three VLIW instructions, when the compiler/scheduler is armed with information about the processor's topology and organization. Similar gains in spite of clustering can be realized in other situations.

Clustering helps alleviate bypass network loading and complexity. Clustering can also be applied to the separate register-files for different clusters, or combined with an inter-clustering communication mechanism to pass operand data from one cluster to the other cluster. A unified register-file provide a way for data to be passed between clusters, albeit at the cost of one instruction delay so the register can load, settle, and be read out.

Each LS unit is complex and costly, and so duplicating a second LS unit for the sake of clustering is prohibitively expensive. Multi-ported LS units that can sustain two load or store operations every VLIW instruction are complex, and the LS units in general need a lot of chip real estate, the extra area needed may simply not be available. If an 8-issue slot-processor does not use a duplicate LS in cluster-2, then cluster-2 cannot be instructed to do any load or store operations.

What is needed is a way to support the duplication and performance gains of many issue slot functional units where bypass network clustering has been used to reduce complexity without significant sacrifices in performance.

In an example embodiment, a virtual functional unit is employed in a statically scheduled VLIW processor. The design offers “virtual” views of the function unit to the processor scheduler, where the amount of virtual views exceeds the amount of physical instantiations of the functional unit.

An advantage of the present invention is significant processor performance improvements can be achieved for those types of functional units that are too difficult or too costly to physically duplicate.

Another advantage of the present invention is a VLIW processor can be simplified with bypass network clustering.

A still further advantage of the present invention is a compiler/scheduler is provided that can accommodate the virtualization of two or more issue slots in a VLIW processor.

The above summary of the present invention is not intended to represent each disclosed embodiment, or every aspect, of the present invention. Other aspects and example embodiments are provided in the figures and the detailed description that follows.

The invention may be more completely understood in consideration of the following detailed description of various embodiments of the invention in connection with the accompanying drawings, in which:

FIG. 1A is a functional block diagram of a four issue slot processor with a bypass network;

FIG. 1B is a functional block diagram of an eight issue slot processor with a single complex bypass network;

FIG. 1C is a functional block diagram of an eight issue slot processor with two small 4-slot bypass network clusters;

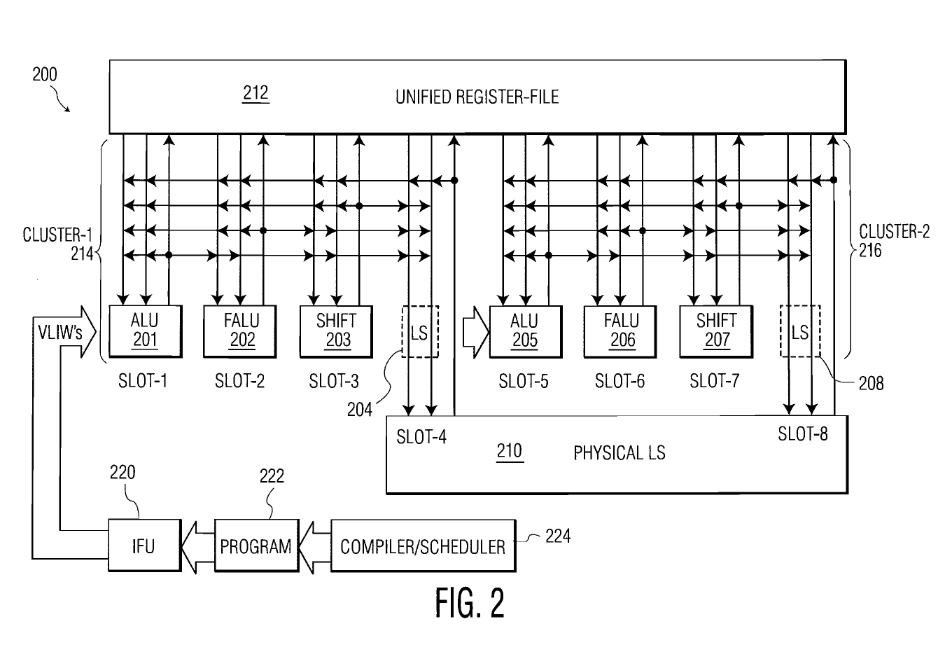

FIG. 2 is a functional block diagram an eight issue slot processor embodiment of the present invention with two 4-slot bypass network clusters that can virtually access the same load-store unit;

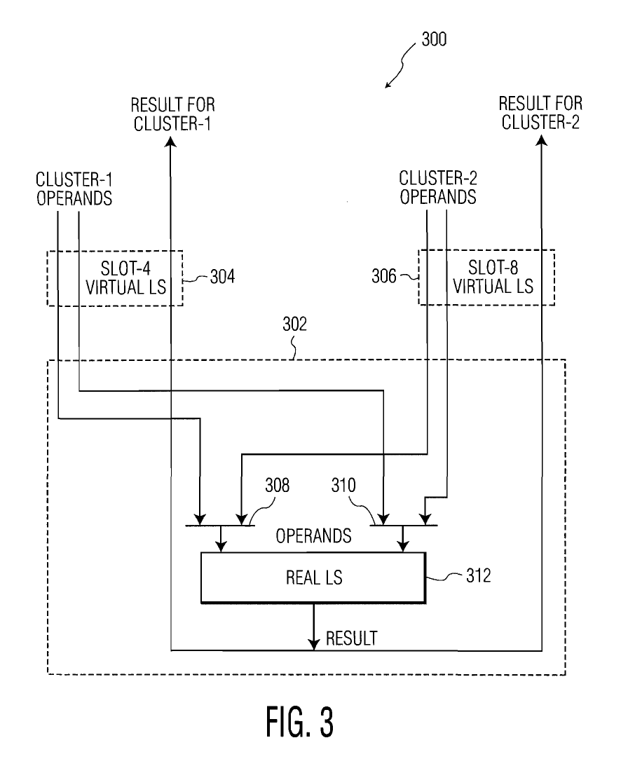

FIG. 3 is a functional block diagram of a load-store device that can be mapped virtually into two clusters as in FIG. 2;

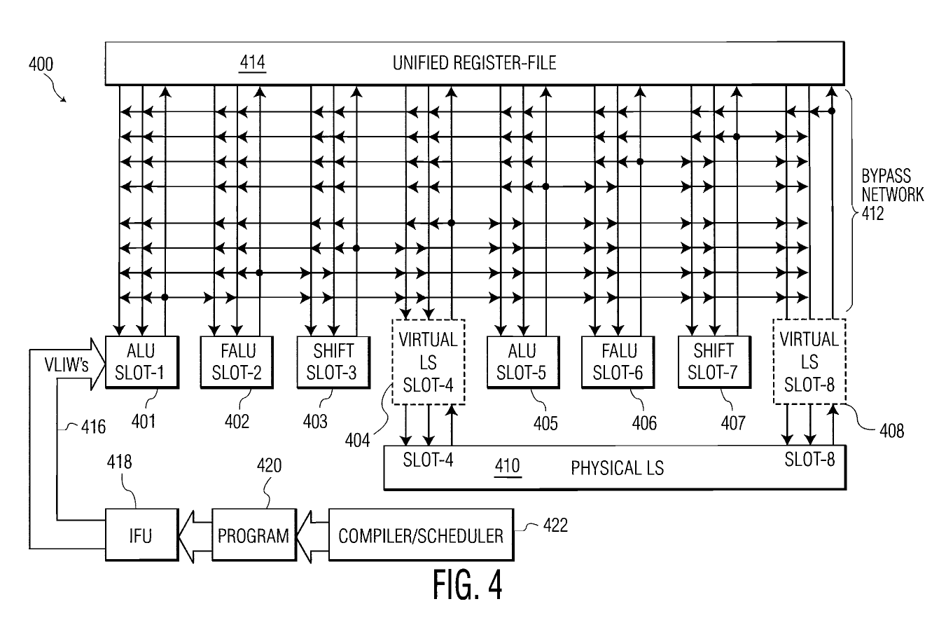

FIG. 4 is a functional block diagram an eight issue slot processor embodiment of the present invention with a single bypass network and where one load-store unit has been virtualized for two issue slots.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

Very long instruction word (VLIW) processors have a number of functional processing units that operate in parallel for each instruction. The VLIW instruction is operated upon by various issue slots, e.g., eight issue slots. Multiple functional units may be used per issue slot. Here, for reasons of simplicity, one functional unit per issue slot is described herein. The NXP TriMedia architecture is one example of a design that has multiple functional units per issue slot. The corresponding part of the VLIW instruction from the instruction fetch unit (IFU) tells the respective ALU, FALU, shifter, and load-store units where to get its input operands and what to do with them. Bypass networks make one functional unit's results available to another in the very next instruction cycle. A unified register file wouldn't be ready to be read until two instruction cycles later. An 8-slot VLIW processor with a single bypass network that can communicate amongst any and all eight issue slots would be too costly and complex for most applications. So smaller 4-slot bypass network clusters are used instead.

FIG. 2 shows one VLIW processor embodiment of the present invention, referred to herein by the general reference numeral 200. The VLIW instruction is operated on by eight functional units in parallel, e.g., ALU 201, FALU 202, SHIFT 203, LS 204, ALU 205, FALU 206, SHIFT 207, and LS 208. However, LS 204 and LS 208 are implemented as virtual load-store units. A single physical LS 210 is multi-ported into their respective bypass network clusters, cluster-1 212, and cluster-2 214. A unified register file 216 receives all the results from every operational unit 201-208, and is ready to be read two instructions later. The bypass network clusters, cluster-1 212, and cluster-2 214, allow results to be read inside their respective clusters only one VLIW instruction later.

A single VLIW instruction for processor 200 can include LS operations in issue slot-4 or issue slot-8, but not both at the same time. If an LS operation needs a result that will appear in cluster-1 212, then that LS instruction must be implement in issue slot-4 for LS 204. Likewise, if an LS operation needs a result that will appear in cluster-2 214, then that LS instruction must be implemented in issue slot-8 for LS 208. The multi-porting in physical LS 210 will be steered to the corresponding cluster.

The VLIW's are presented instruction-by-instruction from an instruction fetch unit (IFU) 220. These are part of a program 224 that was assembled by a compiler/scheduler 224. Such compiler/scheduler 224 is aware of the organization and limitations of issue slots 201-208, cluster-1 212, cluster-2 214, and the one physical LS 210. It assembles program instructions accordingly to make the best use of the resources.

FIG. 2 illustrates the virtualization of a load-store functional processing unit between two clusters. Embodiments of the present invention can virtualize any kind of VLIW functional processing unit to appear as issue slots in two or more clusters.

FIG. 3 provides some more detail how multi-porting or data multiplexers can be used to implement the virtual LS units in slot-4 and slot-8 in cluster-1 and cluster-2, respectively. A circuit 300 connects one multiplexed LS device 302 into a cluster-I virtual LS 304 and a cluster-2 virtual LS 306. Operands from each cluster are selected by data input multiplexers 308 and 310 for a real LS unit 312. The results are broadcast to both clusters. The input multiplexers 308 and 310 would receive instructions on which cluster to read in by sensing instruction-by-instruction which slot-4 or slot-8 was being directed to execute an LS instruction by the IFU.

Referring again to FIG. 1B, NON-clustered processors may benefit from virtual views. By providing multiple virtual views in multiple issue slots of a physical function unit, the compiler/scheduler has more freedom to schedule operations for the functional unit.

FIG. 4 represents a statically scheduled, non-clustered, VLIW processor 400. It includes eight issue slots 401-408, of which two load-store (LS) issue slots 404 and 408 have been virtualized and supported by a single physical LS functional unit 410. A bypass network 412 provides fast operand communication between the eight issue slots 401-508, and a unified register file 414 provides another means to pass data. VLIW's 416 are provided by an instruction fetch unit (IFU) 418 from a program file 420. A compiler/scheduler 422 accommodates the limitations and restrictions imposed by virtualizing some of the issue slots.

While the present invention has been described with reference to several particular example embodiments, those skilled in the art will recognize that many changes may be made thereto without departing from the spirit and scope of the present invention, which is set forth in the following claims.

1. A very long instruction word (VLIW) processor system, comprising:
a plurality of issue slots amongst which a VLIW is operated upon in parallel;
a plurality of bypass network clusters for groups of individual ones of the plurality of issue slots so operational results can be passed directly and avoid delays that would otherwise occur through a unified register file;
a plurality of functional processing units in each of the plurality of issue slots with duplicates assigned to each bypass network cluster;
at least two virtual issue slots each disposed in individual ones of the plurality of bypass network clusters; and
a single functional unit connected through the virtual issue slots and appearing in individual ones of the plurality of bypass network clusters;
wherein, the single functional unit is implemented once with multi-porting and can receive operands and output results over the plurality of bypass network clusters to avoid delays that would otherwise occur through said unified register file.

2. The system of claim 1, further comprising:
an instruction fetch unit (IFU) for presenting each VLIW to the plurality of issue slots;
a program comprising an number of VLIW instructions for access by the IFU; and
a compiler/scheduler which is aware of the organization and limitations of each issue slot, each bypass network cluster, and the single functional unit connected through the virtual issue slots, and for assembling program instructions accordingly to make optimum use of processor resources.

3. The system of claim 1, further comprising:
a load-store unit is included as the single functional unit connected through the virtual issue slots.

4. A very long instruction word (VLIW) processor, comprising:
a set of eight of issue slots amongst which a VLIW is operated upon in parallel;
a pair of bypass network clusters for two groups of individual ones of the eight issue slots so operational results can be passed directly and avoid delays that would otherwise occur through a unified register file;
a plurality of functional processing units in some of the eight of issue slots with duplicates assigned to each bypass network cluster;
at least two load-store virtual issue slots each disposed in individual ones of the pair of bypass network clusters; and
a single load-store functional unit connected through the virtual issue slots and appearing in individual ones of the plurality of bypass network clusters;
wherein, the single load-store functional unit is implemented once with multi-porting and can receive operands and output results for the two bypass network clusters to avoid delays that would otherwise occur if results had to be passed through said unified register file.

5. The VLIW processor of claim 4, further comprising:
an instruction fetch unit (IFU) for presenting each VLIW to the plurality of issue slots; and
a program comprising an number of VLIW instructions for access by the IFU;
wherein, a compiler/scheduler which is aware of the organization and limitations of each issue slot, each bypass network cluster, and the single load-store functional unit connected through the virtual issue slots, is used for assembling program instructions that make optimum use of processor resources.

6. The VLIW processor of claim 4, further comprising:
a compiler/scheduler for accommodating any restrictions with respect to scheduling of operations for functional units with multiple virtual views.

7. A method for reducing construction costs and improving operational performance in a very long instruction word (VLIW) processor, comprising:
grouping issue slots into at least two bypass network clusters; and
virtualizing at least one physical functional unit through multi-porting to appear in at least two bypass network clusters.

8. A non-clustered statically scheduled VLIW processor providing multiple virtual views of a physical function unit in multiple issue slots, and that provides a compiler/scheduler with increased freedom to schedule operations for the functional unit.

9. The processor of claim 8, wherein virtualized functional units, rather than physical duplications of functional units, provide multiple virtual views for some functional units, and such that the virtual views are associated to issue slots and the physical functional unit is shared, and a restriction with respect to mutual exclusive issuing of functional unit operations in the respective issue slots is included in an associated compiler/scheduler.
